(19) United States
(12) Patent Application Publication
(10) Pub. No.: US 2015/0042266 A1
(43) Pub. Date: Feb. 12, 2015

(54) WIRELESS CHARGING DEVICE

(71) Applicant: Kuan-Wei CHEN, Taitung (TW)

(72) Inventor: Kuan-Wei CHEN, Taitung (TW)

(21) Appl. No.: 13/964,109

(22) Filed: Aug. 12, 2013

(51) Int. Cl. H02J 7/02

(52) U.S. Cl. CPC H02J 7/025
USPC 320/108

(57) ABSTRACT

A wireless charging device includes a transmitting station having a first control circuit, a directional antenna, a position tracking member, a first instruction light and a plug. A charging device receives power emitted from the directional antenna of the transmitting station, and includes a second control circuit, a receiver, a position transmitter, a second instruction light, a lithium battery and a connector. The plug is connected with the urban receptacle and the connector of the charging device is connected to the mobile phone. The position tracking member tracks the signals from the directional antenna to position the charging device. The directional antenna sends power to the receiver of the charging device and the power are transferred into mobile power source to charge the mobile phone.

### FIELD OF THE INVENTION

The present invention relates to a charging device, and more particularly, to a wireless charging device having a transmitting station to charge mobile phones.

### BACKGROUND OF THE INVENTION

The conventional way to charge the mobile phones generally requires charging kit which includes a wire, a connector and a plug, and the charging kit has to be connected with a power source to charge the mobile phone. The charging kit has to be carried with the users. When the power of the mobile phone runs out at public sites, the mobile phone cannot be used if no power source is available.

The present invention intends to provide a wireless charging device which can charge the mobile phone from a distance at any time.

### SUMMARY OF THE INVENTION

The present invention relates to a wireless charging device and comprises a transmitting station having a first control circuit, a directional antenna, a position tracking member, a first instruction light and a plug. The first control circuit is connected with the directional antenna, the position tracking member and the first instruction light. The plug is connected to outside of the first control circuit. A charging device receives power emitted from the directional antenna of the transmitting station and transfers the power into mobile power source. The charging device has a second control circuit, a receiver, a position transmitter, a second instruction light, a lithium battery and a connector. The second control circuit is connected with the receiver, the position transmitter, the second instruction light, the lithium battery and the connector.

Preferably, the transmitting station is a semi-circular station.

Preferably, the second control circuit of the charging device is connected with a charging battery which is connected to the connector.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 shows the block diagram of the wireless charging device of the present invention, and

FIG. 2 shows the charging status of the wireless charging device of the present invention.

### DETAILED DESCRIPTION OF THE PREFERRED EMBODIMENT

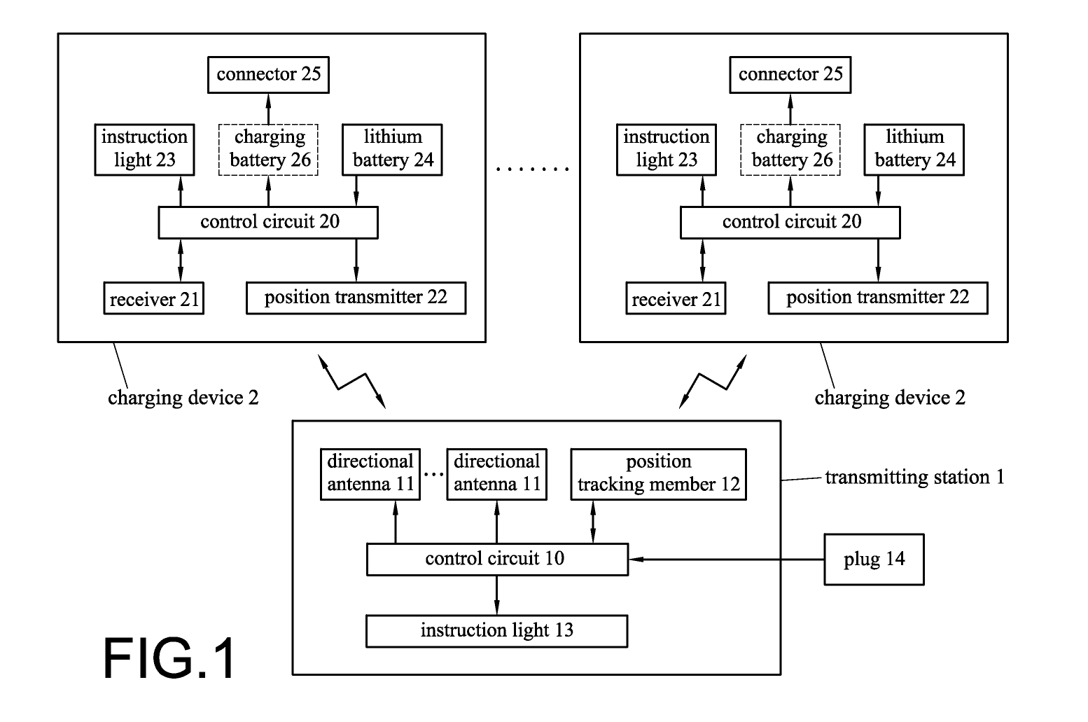

Referring to FIG. 1, the wireless charging device of the present invention comprises a transmitting station 1 which comprises a first control circuit 10, a directional antenna 11, a position tracking member 12, a first instruction light 13 and a plug 14. The transmitting station 1 is a semi-circular station. The first control circuit 10 is connected with the directional antenna 11, the position tracking member 12 and the first instruction light 13. The plug 14 is connected to outside of the first control circuit 10. A charging device 2 receives signals emitted from the directional antenna 11 of the transmitting station 1 and transfers the signals into mobile power source. The charging device 2 comprises a second control circuit 20, a receiver 21, a position transmitter 22, a second instruction light 23, a lithium battery 24 and a connector 25. The second control circuit 20 is connected with the receiver 21, the position transmitter 22, the second instruction light 23, the lithium battery 24 and the connector 25. The second control circuit 20 of the charging device 2 is connected with a charging battery 26 which is connected to the connector 25.

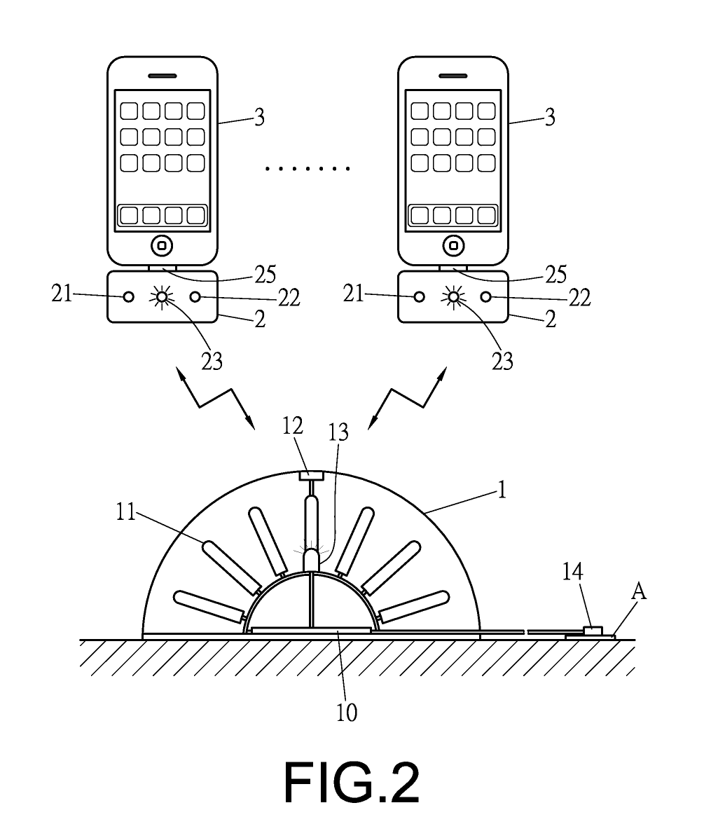

Referring to FIGS. 1 and 2, the plug 14 of the transmitting station 1 is connected to the urban receptacle “A”, and the first instruction light 13 on the transmitting station 1 is on, and the connector 25 of the charging device 2 is connected to the mobile phone 3. The position tracking member 12 of the transmitting station 1 tracks the signals emitted from the position transmitter 22 of the charging device 2 within a pre-set distance to position the charging device 2. The directional antenna 11 of the transmitting station 1 sends power to the receiver 21 of the charging device 2 and the power is transferred into mobile power source by the second control circuit 20 of the charging device 2 to charge the mobile phone 3, or to charge to the charging battery 26 to supply the power to the mobile phone 3 when needed. The second instruction light 23 on the charging device 2 is on so as to achieve the purpose of wireless charging of the mobile phone 3 by the transmitting station 1.

While we have shown and described the embodiment in accordance with the present invention, it should be clear to those skilled in the art that further embodiments may be made without departing from the scope of the present invention.

What is claimed is:

1. A wireless charging device comprising:
a transmitting station having a first control circuit, a directional antenna, a position tracking member, a first instruction light and a plug, the first control circuit connected with the directional antenna, the position tracking member and the first instruction light, the plug connected to outside of the first control circuit, and
a charging device receiving power emitted from the directional antenna of the transmitting station and transferring the power into mobile power source, the charging device having a second control circuit, a receiver, a position transmitter, a second instruction light, a lithium battery and a connector, the second control circuit connected with the receiver, the position transmitter, the second instruction light, the lithium battery and the connector.

2. The device as claimed in claim 1, wherein the transmitting station is a semi-circular station.

3. The device as claimed in claim 1, wherein the second control circuit of the charging device is connected with a charging battery which is connected to the connector.
